(19) United States
(12) Patent Application Publication
(10) Pub. No.: US 2012/0278702 A1
(43) Pub. Date: Nov. 1, 2012

(54) METHOD AND SYSTEM FOR CONTROLLING THE TRANSLATION OF PREDEFINED RULES AND/OR INCOMING DATA OF A DATA STREAM

(75) Inventors: Gero Bäse, Muenchen (DE); Nobert Oertel, Landshut (DE)

(73) Assignee: SIEMENS AKTIENGESELLSCHAFT, MUNCHEN (DE)

(21) Appl. No.: 13/459,427

(22) Filed: Apr. 30, 2012

(30) Foreign Application Priority Data
Apr. 29, 2011 (EP) 11164257

(51) Int. Cl. G06F 17/00

(52) U.S. Cl. 715/239

(57) ABSTRACT

A method controls a translation of predefined rules and/or of incoming data. The data is described in an XML schema. A conversion of hierarchically arranged elements of the XML schema into a list containing list entries is performed. This is effected in that for an element representing a parent component in the XML schema, a fact class is created which for every possible relationship arising from the parent component contains a fact element containing all elements of the path of the relevant relationship of the XML schema, wherein the fact elements represent the list entries of the fact class. At least one of the fact elements is assigned property information which represents a processing instruction for the assigned fact element for the translation of the rules and/or data. A translation of the rules and/or data is affected.

### CROSS-REFERENCE TO RELATED APPLICATION

This application claims the priority, under 35 U.S.C. §119, of European application EP 11164257, filed Apr. 29, 2011; the prior application is herewith incorporated by reference in its entirety.

### BACKGROUND OF THE INVENTION

1. Field of the Invention

The invention relates to a method and a system for controlling the translation of predefined rules and/or incoming data of a data stream, the data of which is present in an XML schema.

The data in the data stream may for example be analysis results of an audio and/or video metadata stream. To enable this data to be processed on an automated basis, it is provided in an XML document. In the present description an XML document means a data stream, the data of which is present in an XML schema. XML is the abbreviation for Extensible Markup Language and constitutes a language for displaying hierarchically structured data in the form of text data. XML is used among other things for the platform-independent and implementation-independent exchange of data between computer systems.

Elements contained in an XML document may be mandatory or optional in nature. In the case of the analysis of the data stream using rules in a rule machine precautions must be taken for optional elements in particular in order to enable correct processing in the rule machine. Until now optional elements have been taken into account manually by a programmer. If optional elements are not correctly mapped in the rules, an unexpected error can occur in the rule machine, resulting in termination of further processing of the data stream by the rule machine.

### SUMMARY OF THE INVENTION

It is therefore desirable to provide the rule machine with a complete and current fact base, it being possible for the optional elements contained in a data stream to be taken into account on an automated basis. It is therefore the object of the present invention to specify a method and a system which enables automated processing of optional elements of a metadata stream, the data of which is present in an XML schema.

The invention proposes a method for controlling the translation of predefined rules or incoming data of a data stream, the data of which is described in an XML schema. The method inventively entails converting hierarchically arranged elements of the XML schema into a list containing list entries. For an element which represents a parent component in the XML schema, a fact class is created which for every possible relationship arising from the parent component contains a fact element containing all elements of the path of the relevant relationship of the XML schema, the fact elements representing the list entries of the fact class. Furthermore, during the conversion at least one of the fact elements is assigned property information, which represents a processing instruction for the assigned fact element for the translation of the rules and/or data. In particular, each of the fact elements can be assigned property information.

There follows a translation of the rules, in that the elements of the XML schema that are contained in a path of the relationships are determined from the fact elements and in accordance with the respective assigned property information are converted to a processing instruction that can be processed by a rule machine. Alternatively or additionally there follows a translation of the data of the data stream into a fact class instance that can be processed by the rule machine, in that according to the property information assigned to a fact element predefined handling of optional elements of the XML schema is affected.

Furthermore, a system for controlling the translation of predefined rules and/or incoming data of a data stream is proposed, the data of which is described in an XML schema. The system is configured to perform a conversion of hierarchically arranged elements of the XML schema into a list containing list entries. For an element that represents a parent component in the XML schema, a fact class is created which for every possible relationship arising from the parent component contains a fact element containing all elements of the path of the relevant relationship of the XML schema, the fact elements representing the list entries of the fact class. In connection with the conversion at least one of the fact elements is assigned property information that represents a processing instruction for the assigned fact element for the translation of the rules and/or data.

The system is further configured to perform a translation of the rules, in that the elements of the XML schema containing a path of the relationship are determined from the fact elements and according to the respective assigned property information are converted to a processing step that can be processed by a rule machine. Alternatively or additionally the system is configured to perform a translation of the data of the data stream into a fact class instance that can be processed by the rule machine, in that according to the property information assigned to a fact element a predefined handling of optional elements of the XML schema is affected.

The conversion of the hierarchically arranged elements of the XML schema into a list of a fact class, the list containing list entries known as fact elements, enables processing instructions to be provided, in particular for optional elements of the XML schema. During the conversion of the XML schema, in which the elements are present in hierarchical form, a conversion into a flat structure is affected. The optional elements and their position within the hierarchical structure are taken into account. Because the optional elements are now contained in the list of a fact class, the processing instructions can be assigned to the optional elements contained therein on the basis of the property information assigned to a fact element. They can then be taken into account on an automated basis during the translation of the rules and/or data of the data stream.

The conversion of the hierarchically structured elements into a list with a flat structure thus creates the possibility of preparing and making available optional elements of an XML schema for subsequent processing, for example by a rule machine.

The elements from the XML document received can be assigned to at least one fact class by use of XSLT style sheets, for example.

In order to keep the number of list entries in a fact class as small as possible it is preferred if the fact class is created for an element that represents the root element of the XML schema. In this embodiment only a single fact class is created for the XML document. Because the paths can here have a multiplicity of elements, this is made apparent in a corresponding number of elements in a fact element.

Alternatively a respective fact class can be created for sibling elements of the XML schema which have a parent component in common. In this type of conversion several fact classes exist side by side, and can be used for the translation of the rules and/or the translation of the incoming data of the data stream. Although in this embodiment a greater number of list entries is present overall across all fact classes, the individual rules can be structured more simply, because the fact elements (can) then each have a smaller number of elements.

In a further expedient embodiment an instruction is created during the translation of rules by the fact class for processing optional elements of the XML schema. This instruction contains details of how the rule machine should handle optional elements. In particular, precautions can thereby be taken to ensure that an optional element does not comprise any content information. Such an error query, handled by the rules, avoids unwanted errors which could result in the termination of the rule machine.

In a further expedient embodiment a default value is assigned, during the translation of data of the data stream, to optional elements for which no data value is contained in the data of the data stream. This default value is treated by the rule machine like an actual measurement value or analysis value of the data stream. This too can prevent unexpected errors in the rule machine during its operation.

It is further expedient if optional elements of the XML schema are again assigned the corresponding default value after an initialization of the rule machine because of a change in one of the rules and/or an addition of a new rule. This too can ensure that optional elements always contain a content value—the default value or an actual measurement value or analysis value of the data stream—so that an unexpected error cannot occur in the rule machine.

According to a further expedient embodiment a number of fact classes are assigned to a fact category, a fact category containing information about predefined processing modes for at least several of the fact elements contained in a fact class or the elements of the XML schema contained in the fact elements. This enables defined handling methods to be laid down for the elements contained in a fact class. As a result, a structured option for the efficient handling of incoming XML documents is provided.

According to a further expedient embodiment the property information contained in the fact class for the translation of the rules and/or data of the data stream is read out and processed on an automated basis. In particular, this means that during the runtime of the rule machine amended or supplemented rules do not require any manual intervention by an administrator, because parameters concerning the processing during the translation are already contained in the property information which is assigned to respective fact elements of a fact class.

In a further expedient embodiment the fact class instance contains a structure corresponding to the fact class and contains list entries which comprise the values taken from the data of the data stream and optionally values created in accordance with the property information for the optional elements of the XML document.

With the foregoing and other objects in view there is provided, in accordance with the invention a system for controlling a translation of predefined rules and/or incoming data of a data stream, the incoming data being described in an XML schema. The system containing a processor programmed to perform a conversion of hierarchically disposed elements of the XML schema into a list containing list entries. The processor further programmed to:
create for an element that represents a parent component in the XML schema, a fact class which for every possible relationship arising from the parent component comprises a fact element having all elements of a path of a relevant relationship of the XML schema, wherein fact elements represent the list entries of the fact class;
assign at least one of the fact elements property information representing a processing instruction for the assigned fact element for the translation of the predefined rules and/or the incoming data;
perform the translation of the predefined rules, in that the elements of the XML schema contained for a path of a relationship are determined from the fact elements and are converted in accordance with the respective assigned property information into a processing instruction that can be processed by a rule machine; and/or

perform the translation of the incoming data of the data stream into a fact class instance that can be processed by the rule machine, in that according to the property information assigned to a fact element a predefined handling of optional elements of the XML schema is affected.

Other features which are considered as characteristic for the invention are set forth in the appended claims.

Although the invention is illustrated and described herein as embodied in a method for controlling the translation of predefined rules and/or incoming data of a data stream, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is a schematic illustration of a conversion of an XML document present in hierarchical form into a flat structure according to the invention; and

FIG. 2 is a schematic illustration of an inventive system for controlling the translation of predefined rules and/or incoming data of a data stream.

### DETAILED DESCRIPTION OF THE INVENTION

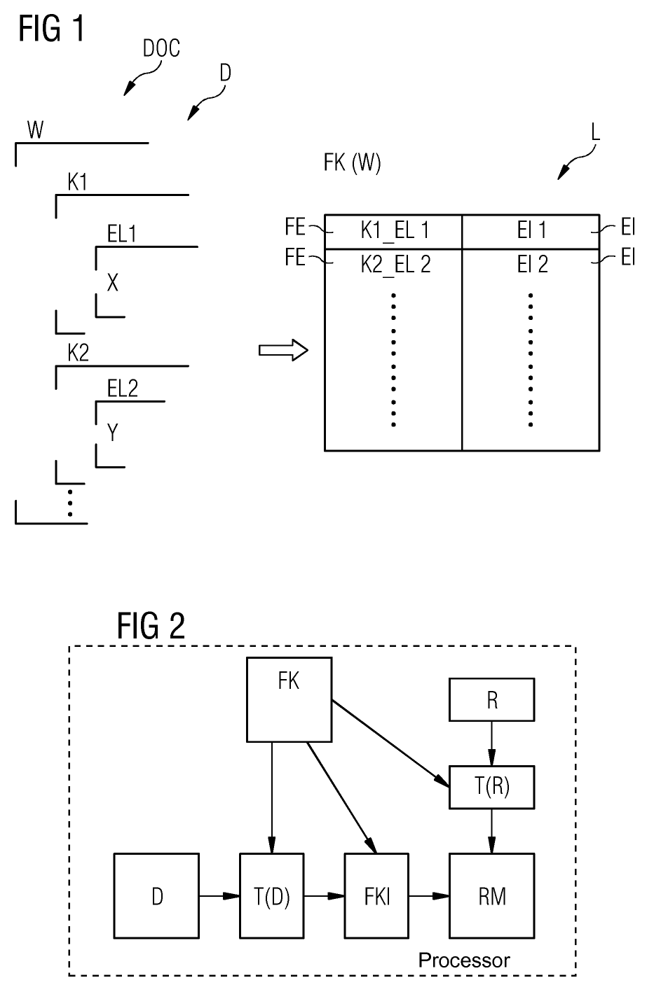

FIG. 1 shows a schematic illustration of the conversion of hierarchically arranged elements of an XML document DOC into a list L with a multiplicity of list entries which are used for translating rules and/or incoming data of a data stream, the data of which is present in an XML document. Before the rules and/or the data of the data stream can be translated, it is necessary to convert the hierarchically arranged elements of the XML schema illustrated in FIG. 1. The XML document illustrated on the left in FIG. 1 contains three hierarchy levels. The top hierarchy level contains for example a root element W. The root element W represents a parent component for the children K1, K2. The children K1, K2 represent sibling elements. The element K1 is in turn a parent component of the element EL1 with the data value X. In corresponding fashion the element K2 represents the parent component of the element EL2, the data value of which is Y. In practice an XML document DOC can have a very much larger number of hierarchies. Likewise any number of sibling elements of a hierarchy level can be provided.

The difficulty when analyzing the XML document DOC containing hierarchically arranged elements is that many elements below the top hierarchy level may be of an optional nature. To ensure defined processing even of optional elements of the XML document DOC, the elements W, K1, K2, EL1, EL2 contained therein are converted to a list L containing list entries, with a fact element FK containing all elements of the path of the relevant relationship of the XML document being created for every possible relationship arising from a parent component.

The present exemplary embodiment starts from the root element W. The fact class is hence designated as FK(W). The XML document DOC shown in FIG. 1 has two paths. The first path starts from the root element W and leads via K1 to the element EL1. The second path likewise starts from the root element and leads via the element K2 to the element EL2. A fact element FE is created as a list entry for each of the paths. The first list entry K1_EL1 is assigned property information EI1. Likewise the second list entry K2_EL2 is assigned property information EI2. Depending on the complexity of the XML document DOC a fact class FK can comprise a large number of list entries in the form of fact elements FE.

The property information El contains processing instructions for each “path”, i.e. each fact element FE, which must be adhered to for the translation of the rules and/or data of the data stream. If the element EL1 is for example an optional element, information about how the element EL1 is to be processed is contained in the property information EI. For example, the property information EI1 can contain information for the translation of a rule to the effect that a check should be made for the presence of the element EL1. Only if the element EL1 is contained is a “then” instruction executed. Otherwise the element EL1 is e.g. skipped. In respect of the translation of the data of the data stream the property information EL1 can for example contain the assignment of a default value for the element EL1, providing the element EL1 is not populated with a value from the data stream.

In the present exemplary embodiment only a fact class FK(W) that starts from the root element has been created for the XML document DOC. In a more highly complex XML document with a larger number of hierarchies a larger number of fact classes could be provided, a respective fact class being created for example for sibling elements of the XML document which have a parent component in common.

FIG. 2 shows a schematic illustration of the inventive system for controlling the translation of predefined rules R and/or incoming data D of a data stream. The data D is present in the shape of the XML document DOC illustrated in FIG. 1. T(R) and T(D) each indicate translators for the rules R and the data D. The translated rules are made available to a rule machine RM for processing. The translation of the data D by means of the translator T(D) results in a fact class instance FKI. A fact class instance FKI contains a structure corresponding to the fact class FK(W) containing list entries which comprise values taken from the data D of the data stream and values created in accordance with the property information EI for the optional elements of the data stream. This information, designated as facts, is passed to the rule machine RM for further processing on the basis of the translated rules. The result of the rule machine is a fact base.

The created fact classes FK described above are firstly made available to the translators T(R) and T(D). Secondly, on the basis of the fact class, the fact class instance is created as described above.

A translation of the rules R is effected, in that from the fact elements of the fact class or classes the elements K1, EL1 or K2, EL2 contained therein of the XML document are determined and in accordance with the respective assigned property information are forwarded to a processing instruction that can be processed by the rule machine RM. Whereas the creation of the fact classes and property information EI contained therein is effected manually by an administrator or programmer, the translation of the rules can be automated on the basis of the information made available. This is even possible if at the runtime of the rule machine a rule changes or a rule is added.

A translation of the data D of the data stream is effected in a fact class instance FKI that can be processed by the rule machine RM, in that according to the property information E1 assigned to a fact element a predefined handling of optional elements K1, EL1, K2, EL2 of the fact class FK(W) of the XML document is effected, it being possible, in particular during the translation of the data D of the data stream, to assign a default value to optional elements for which no data value is contained in the data D of the data stream.

Likewise provision can also be made for the renewed assignment of a default value of the optional element if the rule machine was initialized on the basis of a change of one of the rules or an addition of a new rule.

To ensure that the facts for the rule machine RM are complete and current, the data contained in the XML document DOC is preprocessed. A parser can be used for this, which with reference to the existing XML schema can determine which elements are actually present in the data D. Because it is also known which elements are required by the rule machine RM, optional elements can be assigned subsequent values (default values). Optionally a time parameter can be provided, before the data is converted as facts into the fact memory of the rule machine. The time parameters are in particular appropriate for those optional elements that retain their current value until a change occurs. Because in the case of rule machines fact memories are generally completely deleted before they are reinitialized, the time parameters can be used to reinsert the facts during the next initialization, if no change has occurred by then.

Another structured opportunity for the efficient handling of incoming XML documents consists in combining several fact classes into fact categories. The fact class is used to determine defined handling methods (by means of the property information) for the fact elements contained in the fact class. For example, all elements classified in a fact class “Properties” can immediately be made available as facts, because it can be assumed that all associated elements used in the rules are already present. Properties are mostly used to represent dynamic behavior of objects in a scene of a video. A property is for example “XY has entered/left a particular area”, “XY is no longer moving”, etc.

So-called “notification messages” can be regarded as an example of a fact category. These are split e.g. into fact classes, such as alarms for devices (e.g. fluctuations in a power supply), alarms for algorithms (an object has entered a prohibited area), etc. through to messages about lack of lighting in an area to be monitored or the need for a backup for a critical storage medium. A particular type of handling can be laid down for a fact category, e.g. “the fact classes contained therein must always be archived”, while for each of the fact classes special parameters apply for how these are converted to the fact base.

The elements from the XML document received can be assigned to the fact classes by use of an XSLT stylesheet, for example.

Before being forwarded to the fact base, the elements can be filtered using a CEP (Complex Event Processing) engine or a “Stream Processing Engine”, for example.

A particular difficulty arises when setting up a connection. Because all optional elements are not present immediately, for example depending on a predefined transmission interval, data can be buffered and accumulated until a predefined structure is completed. This approach entails a delay of unknown duration and cannot be applied for events. Alternatively, a predefined value is supplied to the rule machine for elements not yet present, to enable partial analyses of the rules.

1. A method for controlling a translation of predefined rules and/or incoming data of a data stream, the incoming data being described in an XML schema, which comprises the steps of:
providing a processor and performing, via the processor, a conversion of hierarchically arranged elements of the XML schema into a list containing list entries with the processor performing the further steps of:
creating, for an element that represents a parent component in the XML schema, a fact class which for every possible relationship arising from the parent component containing a fact element having all the elements of a path of a relevant relationship of the XML schema, wherein fact elements represent list entries of the fact class;
assigning at least one of the fact elements property information representing a processing instruction for an assigned fact element for the translation of the predefined rules and/or the incoming data;
effecting the translation of the predefined rules, in that from the fact elements the elements of the XML schema contained in the path of the relevant relationship are determined and according to a respective assigned property information are converted into a processing instruction that can be processed by a rule machine; and/or
effecting the translation of the incoming data of the data stream into a fact class instance that can be processed by the rule machine, in that according to the property information assigned to the fact element a predefined handling of optional elements of the XML schema is affected.

2. The method according to claim 1, which further comprises creating the fact class for an element that represents a root element of the XML schema.

3. The method according to claim 1, which further comprises creating a respective fact class for sibling elements of the XML schema which have a parent component in common.

4. The method according to claim 1, which further comprises during the translation of predefined rules by means of the fact class, creating an instruction for the processing of the optional elements of the XML schema.

5. The method according to claim 1, which further comprises during the translation of the incoming data of the data stream a default value is assigned to the optional elements for which no data value is contained in the incoming data of the data stream.

6. The method according to claim 1, which further comprises assigning the optional elements of the XML schema, a corresponding default value after an initialization of the rule machine because of a change in one of the predefined rules and/or an addition of a new rule.

7. The method according to claim 1, which further comprises assigning a number of fact classes to a fact category, the fact category containing information about predefined processing modes for at least several of the fact elements contained in one of the fact classes or the elements of the XML schema contained in the fact elements.

8. The method according to claim 1, which further comprises reading out the property information for the translation of the predefined rules and/or the incoming data of the data stream which is contained in the fact class and processed on an automated basis.

9. The method according to claim 1, wherein the fact class instance contains a structure having the list entries corresponding to a fact class, the list entries having values taken from the incoming data of the data stream and values created in accordance with the property information for the optional elements of the data stream.

10. A system for controlling a translation of predefined rules and/or incoming data of a data stream, the incoming data being described in an XML schema, the system comprising:
a processor programmed to perform a conversion of hierarchically disposed elements of the XML schema into a list containing list entries, said processor further programmed to:
create for an element that represents a parent component in the XML schema, a fact class which for every possible relationship arising from the parent component comprises a fact element having all elements of a path of a relevant relationship of the XML schema, wherein fact elements represent the list entries of the fact class;
assign at least one of the fact elements property information representing a processing instruction for the assigned fact element for the translation of the predefined rules and/or the incoming data;
perform the translation of the predefined rules, in that the elements of the XML schema contained for a path of a relationship are determined from the fact elements and are converted in accordance with the respective assigned property information into a processing instruction that can be processed by a rule machine; and/or
perform the translation of the incoming data of the data stream into a fact class instance that can be processed by the rule machine, in that according to the property information assigned to a fact element a predefined handling of optional elements of the XML schema is affected.
